(19) United States
(12) Patent Application Publication
(10) Pub. No.: US 2019/0225365 A1
(43) Pub. Date: Jul. 25, 2019

(54) SHIPPING AND DISPLAY CONTAINER AND METHOD FOR FORMING THE SAME

(71) Applicant: WestRock Shared Services, LLC, Atlanta, GA (US)

(72) Inventors: David G. Couture, Horschton, GA (US); Amer Aganovic, Orlando, FL (US); Thomas Dean Graham, Winter Garden, FL (US)

(21) Appl. No.: 16/253,306

(22) Filed: Jan. 22, 2019

Related U.S. Application Data
(60) Provisional application No. 62/621,778, filed on Jan. 25, 2018.

(51) Int. Cl. B65D 5/32; B65D 5/64; B31B 50/62; B31B 50/26

(52) U.S. Cl. CPC B65D 5/321; B65D 5/64; B31B 2120/10; B31B 50/26; B31B 50/624

(57) ABSTRACT

A container and blanks and a blank assembly for forming the container are provided herein. The container includes a tray, the tray including a pair of tray side walls, a pair of tray end walls, and a first glue panel coupled to one of the tray end walls. The container also includes a cover releasably coupled to the tray to transition the container from a shipping to a display configuration, the cover including a pair of cover side walls aligned with the pair of tray side walls, a pair of cover end walls aligned with the pair of tray end walls, and a second glue panel coupled to one of the cover end walls. At least a portion of the tray overlaps with at least a portion of the cover, and the first and second glue panels are vertically aligned with and uncoupled from one another.

### REFERENCE TO RELATED APPLICATION

This application claims the benefit of priority under 35 U.S.C. § 119(e) of U.S. provisional application Ser. No. 62/621778 filed on Jan. 25, 2018, which is hereby incorporated by reference in its entirety.

### BACKGROUND

The field of the present disclosure relates generally to packaging containers and, more particularly, to a two-piece shipping and display container and methods of forming the same.

Containers fabricated from paperboard and/or corrugated paperboard material are often used to store and transport goods. Such containers are usually formed from blanks of sheet material that are folded along a plurality of preformed fold lines to form an erected corrugated container. At least some known blanks include a pair of end panels, a pair of side panels, a glue panel, a bottom panel, and, in some cases, a top panel, connected by a plurality of fold lines. The panels are rotated to form end walls, side walls, a bottom wall, and a top wall of the container. In some cases, these containers can be used to ship goods, and then be used to display the goods at a merchant's store or business after the goods have been shipped to the merchant.

The practice of displaying goods for sale within their shipping containers is widespread, especially at outlet stores and supermarkets. This practice allows merchants of the goods to quickly move the goods from a dock or storage area and onto store shelves for display to consumers without arrangement of the stored products on the shelf. In addition, at least some known shipping containers include a reinforcement panel in series with the side and end panels. The reinforcement panel adds strength and/or other desirable properties to the container walls. Often, a knife is used to cut away a top portion of a shipping container, in order to convert the shipping container into a display tray for the enclosed goods. This practice is often time consuming, may result in damage to the goods through inadvertent contact with the knife during this cutting, as well as dangerous to the individual cutting the box down into a tray. Moreover, this practice often results in a display tray having a ragged, unappealing visual appearance.

Accordingly, it is desirable to have a convertible shipping container that provides reinforcement panels, displays a visual appealing greater portion of the container to the consumer, and provides for more convenient removal of the product from the container.

### BRIEF DESCRIPTION

In one aspect, a blank assembly for forming a container is provided. The blank assembly includes a tray blank for forming a tray of the container. The tray blank includes a first plurality of side panels coupled together in series, a first glue panel extending from the first plurality of side panels, and a plurality of bottom panels extending from the first plurality of side panels along a corresponding plurality of bottom fold lines. The blank assembly also includes a cover blank for forming a removable cover of the container. The cover blank includes a second plurality of side panels coupled together in series and a second glue panel extending from the second plurality of panels. The tray blank and the cover blank are releasably coupled together in an overlapping relationship such that a free bottom edge of the cover blank is aligned with the plurality of bottom fold lines of the tray blank, and the first glue panel and the second glue panel are aligned with one another and uncoupled from one another such that each of the first and second glue panels are configured to be independently folded to form the container from the blank assembly.

In another aspect, a container is provided. The container includes a tray formed from a tray blank, the tray including a pair of opposing tray side walls, a pair of opposing tray end walls, and a first glue panel coupled to one of the tray end walls. The container also includes a cover formed from a cover blank, the cover releasably coupled to the tray to transition the container from a shipping configuration to a display configuration. The cover includes a pair of opposing cover side walls aligned with the pair of tray side walls, a pair of opposing cover end walls aligned with the pair of tray end walls, and a second glue panel coupled to one of the cover end walls. At least a portion of the tray overlaps with at least a portion of the cover, and the first and second glue panels are vertically aligned with one another and uncoupled from one another.

### BRIEF DESCRIPTION OF THE DRAWINGS

FIG. 1 is a top plan view of a tray blank of sheet material for constructing a container according to an embodiment of the present disclosure.

FIG. 2 is a top plan view of a cover blank of sheet material for constructing a container according to an embodiment of the present disclosure.

FIG. 3 is a top plan view of a blank assembly including the tray blank shown in FIG. 1 in an overlapping relationship with the cover blank shown in FIG. 2.

FIG. 4 is a perspective view of a container formed from the blank assembly shown in FIG. 3, in a shipping configuration.

FIG. 5 is a perspective view of the container shown in FIG. 4 separated into a tray and a removable cover.

FIG. 6 is a top plan view of an alternative configuration of a blank assembly including the tray blank shown in FIG. 1 in an overlapping relationship with an alternative cover blank.

FIG. 7 is a perspective view of a container formed from the blank assembly shown in FIG. 6, in a shipping configuration.

FIG. 8 is a perspective view of the container shown in FIG. 7 separated into a tray and a removable cover.

FIG. 9 is a perspective view of the container shown in FIG. 4 or the container shown in FIG. 7 in a display configuration.

FIG. 10 is a side view of a portion of a machine that may be used to form the container shown in FIG. 4 and the container shown in FIG. 7 by wrapping a respective blank assembly around a mandrel.

FIGS. 11 and 12 are side views of an embodiment of the machine shown in FIG. 10 wrapping the respective blank assembly around the mandrel.

FIGS. 13 and 14 are side views of another embodiment of the machine shown in FIG. 10 wrapping the respective blank assembly around the mandrel.

FIG. 15 is a perspective view of a tool used to wrap the blank assembly around the mandrel shown in FIG. 10.

FIG. 16 is an end view of an alternative tool used to wrap the blank assembly around the mandrel shown in FIG. 10.

FIG. 17 is a top plan view of an alternative embodiment of the tray blank shown in FIG. 1.

FIG. 18 is a top perspective view of a container formed from a blank assembly similar to the blank assembly shown in FIG. 3 shown in a knocked-down-flat configuration.

FIG. 19 is a top plan view of a tray blank of sheet material similar to the tray blank shown in FIG. 1 for constructing a container.

FIG. 20 is a top plan view of a cover blank of sheet material similar to the cover blank shown in FIG. 2 for constructing a container.

FIG. 21 is a top plan view of a blank assembly including the tray blank shown in FIG. 19 in an overlapping relationship with the cover blank shown in FIG. 20, similar to the blank assembly shown in FIG. 3.

FIG. 22 is a perspective view of a container formed from the blank assembly shown in FIG. 21, in a shipping configuration, similar to the container shown in FIG. 4.

FIG. 23 is a perspective view of the container shown in FIG. 22 separated into a tray and a removable cover, similar to the container shown in FIG. 5.

### DETAILED DESCRIPTION

The following detailed description illustrates the disclosure by way of example and not by way of limitation. The description enables one skilled in the art to make and use the disclosure, describes several embodiments, adaptations, variations, alternatives, and use of the disclosure, including what is presently believed to be the best mode of carrying out the disclosure.

A two-piece shipping and display container (also known as a “Retail-Ready Package” (RRP)) and a blank assembly for constructing the same are described herein. The blank assembly includes a tray blank and a cover blank that are coupled together to form the container that includes a tray and a removable cover. Each of the tray blank and cover blank includes a respective glue panel. When the tray blank and the cover panel are coupled together to form the container, the glue panels align but remain separate or un-coupled from one another. Accordingly, the ease of separating the formed cover from the formed tray is improved, while maintaining the structural integrity of the tray and the cover individually and of the overall container. The resulting container thereby maintains the necessary or expected stacking strength while improving the convertibility of the container from a shipping configuration to a display configuration. It will be apparent to those skilled in the art and guided by the teachings herein provided that the disclosure is likewise applicable to any storage container including, without limitation, a carton, a tray, a box, or a bin. In the example embodiment, the container is configured to be used as a shipping container that can be converted into a display tray configuration.

In one embodiment, the container is fabricated from a paperboard material, such as one of a corrugated paperboard material, a folding carton paperboard material, or a combination of corrugated and folding carton paperboard material. The container, however, may be fabricated using any suitable material, and therefore is not limited to a specific type of material. In alternative embodiments, the container is fabricated using cardboard, fiberboard, paperboard, foamboard, corrugated paper, and/or any suitable material known to those skilled in the art and guided by the teachings herein provided. The container may have any suitable size, shape, and/or configuration, whether such sizes, shapes, and/or configurations are described and/or illustrated herein. Further, different embodiments described here can vary in size and/or dimensions. The container may also include lines of perforation for removal of a portion of the container for displaying articles for sale.

In an example embodiment, the container includes at least one marking thereon including, without limitation, indicia that communicates the product, a manufacturer of the product, and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to including, ink jet printing, laser printing, screen printing, giclée, pen and ink, painting, offset lithography, flexography, relief print, rotogravure, dye transfer, and/or any suitable printing technique known to those skilled in the art and guided by the teachings herein provided. In another embodiment, the container is void of markings, such as, without limitation, indicia that communicates the product, a manufacturer of the product, and/or a seller of the product.

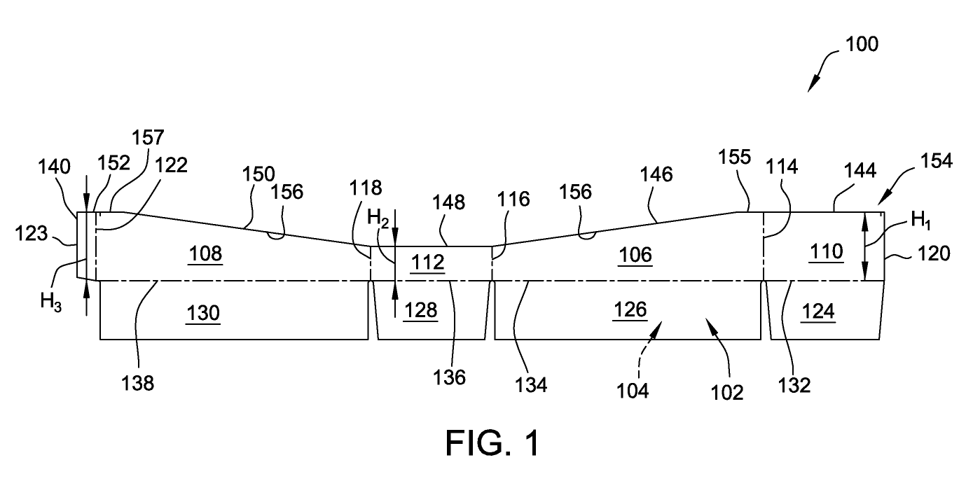

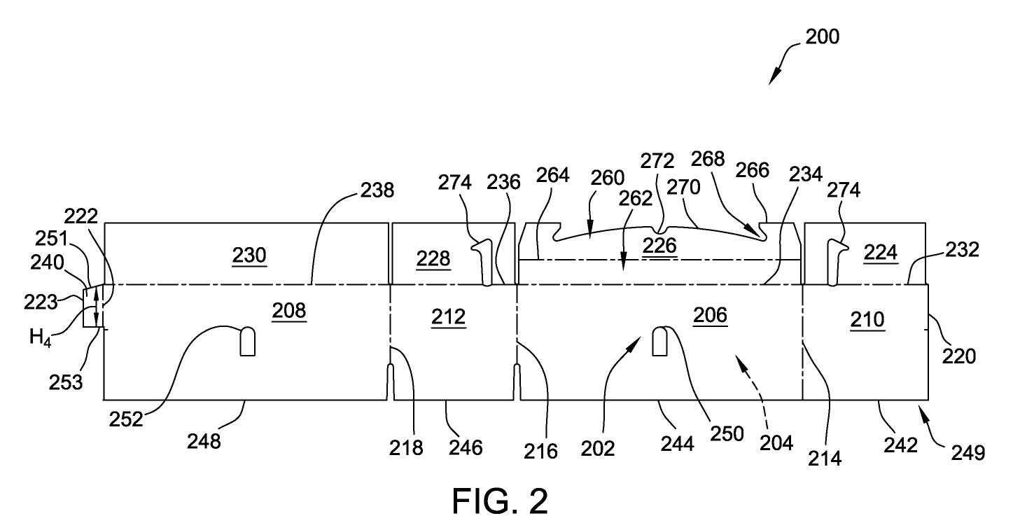

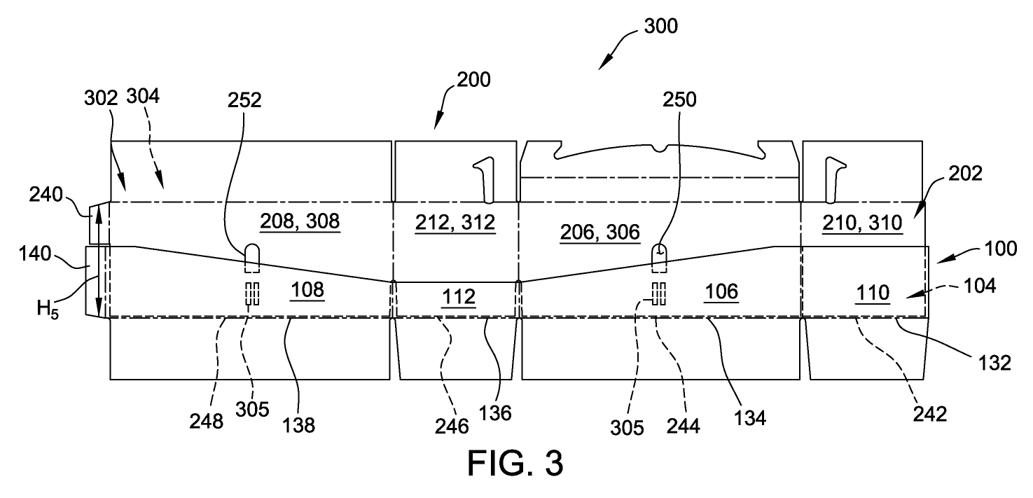

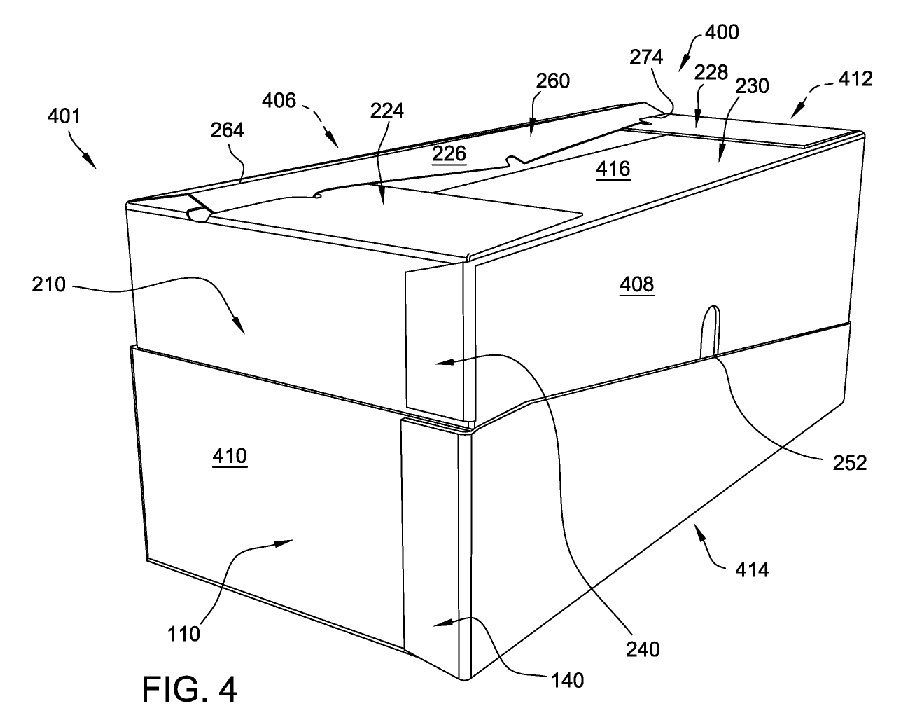

Referring now to the drawings, FIG. 1 is an exterior view of an example embodiment of a tray blank 100 of sheet material that may be used to form a container as described herein. As explained below in more detail, tray blank 100 is coupled to another blank (a cover blank 200, shown in FIG. 2) to form a blank assembly 300 (shown in FIG. 3) that is used to form a container 400 (shown in FIG. 4). Tray blank 100 includes an exterior surface 102 and an interior surface 104. As shown in FIG. 1, tray blank 100 includes a series of aligned side panels and end panels coupled together in series along preformed, generally parallel, fold lines. Specifically, the side panels include a first side panel 106 and a second side panel 108, and the end panels include a first end panel 110 and a second end panel 112. First end panel 110, first side panel 106, second end panel 112, and second side panel 108 are coupled together in series along preformed fold lines 114, 116, and 118, respectively. First end panel 110 extends from a first free edge 120 to fold line 114, first side panel 106 extends between first and second end panels 110 and 112 from fold line 114 to fold line 116, second end panel 112 extends between first side panel 106 and second side panel 108 from fold line 116 to fold line 118, and second side panel 108 extends from fold line 118 to a fold line 122. A glue panel 140 extends from second side panel 108 along fold line 122, to a second free end 123.

Tray blank 100 also includes a first bottom flap 124 coupled to first end panel 110 along a fold line 132. A second bottom flap 126 is coupled to first side panel 106 along a fold line 134, a third bottom flap 128 is coupled to second end panel 112 along a fold line 136, and a fourth bottom flap 130 is coupled to second side panel 108 along a fold line 138. Fold lines 132, 134, 136, and 138 are generally parallel to one another and generally perpendicular to fold lines 114, 116, 118, and 122.

Tray blank 100 further includes a first top edge 144 of first end panel 110, a second top edge 146 of first side panel 106, a third top edge 148 of second end panel 112, a fourth top edge 150 of second side panel 108, and a fifth top edge 152 of glue panel 140. Top edges 144, 146, 148, 150, and 152 are substantially continuous with one another and collectively define a “clean” tray top edge 154 of tray blank 100 (e.g., no detritus from removal of a perforated section). In the illustrated embodiment, top edges 146 and 150 include respective first, generally horizontal portions 155 and 157 as well as respective angled portions 156 and 158, such that tray blank 100 has a varying height (e.g., from a first height H₁ of first end panel 110 to a second height H₂ of second end panel 112). In an alternative embodiment, top edges 146 and 150 do not include angled portions 156 and 158, such that tray blank 100 has a substantially uniform height. In the illustrated embodiment, glue panel 140 has a height H₃ that is substantially equal to first height H₁ of first end panel 110.

Turning now to FIG. 2, an exterior view of an example embodiment of a cover blank 200 of sheet material that is configured to releasably couple to tray blank 100 (shown in FIG. 1) to form container 400 (shown in FIG. 4) is illustrated. In the example embodiment, cover blank 200 includes an exterior surface 202 and an interior surface 204. As shown in FIG. 2, cover blank 200 includes a series of aligned side panels and end panels connected together by a plurality of preformed, generally parallel, fold lines. Specifically, the side panels include a first side panel 206 and a second side panel 208, and the end panels include a first end panel 210 and a second end panel 212. First end panel 210, first side panel 206, second end panel 212, and second side panel 208 are coupled together in series along preformed fold lines 214, 216, and 218, respectively. First end panel 210 extends from a first free edge 220 to fold line 214, first side panel 206 extends between first and second end panels 210 and 212 from fold line 214 to fold line 216, second end panel 212 extends between first side panel 206 and second side panel 208 from fold line 216 to fold line 218, and second side panel 208 extends from fold line 218 to a fold line 222. A glue panel 240 extends from second side panel 208 along fold line 222, to a second free edge 223.

Cover blank 200 also includes a first top flap 224 coupled to first end panel 210 along a fold line 232. A second top flap 226 is coupled to first side panel 206 along a fold line 234, a third top flap 228 is coupled to second end panel 212 along a fold line 236, and a fourth top flap 230 is coupled to second side panel 208 along a fold line 238. Fold lines 232, 234, 236, and 238 are generally parallel to one another and generally perpendicular to fold lines 214, 216, 218, and 222.

Cover blank 200 further includes a first bottom edge 242 of first end panel 210, a second bottom edge 244 of first side panel 206, a third bottom edge 246 of second end panel 212, and a fourth bottom edge 248 of second side panel 208. Bottom edges 242, 244, 246, and 248 are substantially continuous with one another and collectively define a “clean” cover bottom edge 249 of cover blank 200 (e.g., no detritus from removal of a perforated section).

In the illustrated embodiment, glue panel 240 has a height H₄ that extends from a top edge 251 to a bottom edge 253 of glue panel 240. Height H4 does not, in the illustrated embodiment, extend a full height of cover blank 200, or even a full height of second side panel 208. Put another way, glue panel 240 extends only partially along second side panel 208, or fold line 222 extends only partially along second side panel 208. As described further herein, having glue panel 240 be “shorter” than the rest of cover blank 200 facilitates the simultaneous folding of cover blank 200 and tray blank 100 (collectively a blank assembly 300, shown in FIG. 3) about a mandrel to form a container therefrom.

In the illustrated embodiment, free edges 220 and 223 and fold lines 214, 216, 218, and 222 are generally parallel to one another and are generally perpendicular to fold lines 232, 234, 236, and 238, and to bottom edges 242, 244, 246, and 248.

In addition, first side panel 206 includes a first cutout 250, and second side panel 208 includes a second cutout 252. First cutout 250 and second cutout 252 may have any suitable size, shape, and/or configuration that enables container 400 to function as described herein. In alternative embodiments, cover blank 200 does not include cutouts 250 and/or 252.

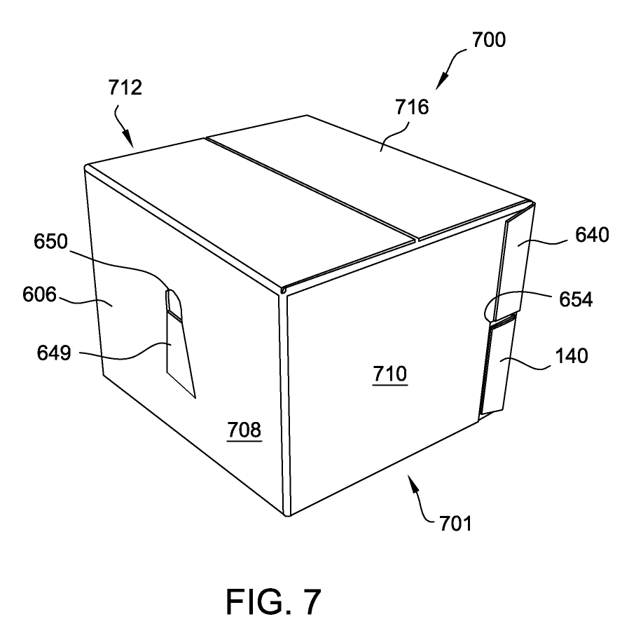

In the illustrated embodiment, second top flap 226 includes a first portion 260 and a second portion 262, wherein second portion 262 extends from first side panel 206 along fold line 234 and first portion 260 extends from second portion 262 along a fold line 264. Fold line 264 may be generally parallel to fold line 234. Second portion 262 is generally rectangular in the illustrated embodiment, and first portion 260 includes additional features that facilitate an “easy open” container top wall, as described further herein. More particularly, first portion 260 includes two opposing, generally symmetrical tabs 266 that define respective channels 268. In addition, an arcuate free edge 270 of first portion 260 (opposite fold line 264) defines a recess therein. Each of first top flap 224 and third top flap 228 includes a cutout 274 defined therein. As described further herein, each cutout 274 is configured to receive one of tabs 266 therein to facilitate engaging second top flap 226 with first and third top flaps 224, 228 to form a top wall of a container. In other embodiments, cover blank 200 includes top flaps configured to form a top wall of a regular slotted container (RSC) that may be closed with tape, for example, or any other adhesive. An example of this embodiment of a top wall of an RSC is illustrated in FIG. 7, with respect to container 700 (i.e., a top wall 716).

FIG. 3 is an exterior view of an example embodiment of a blank assembly 300, including tray blank 100 overlapping and releasably coupled to cover blank 200. To form blank assembly 300, interior surface 104 of tray blank 100 is coupled to exterior surface 202 of cover blank 200. More specifically, fold lines 132, 134, 136, and 138 of tray blank 100 are aligned with bottom edges 242, 244, 246, and 248 of cover blank 200, respectively, such that tray blank 100 at least partially covers exterior surface 202 of cover blank 200. Accordingly, an exterior surface 302 of blank assembly 300 includes exterior surface 102 (shown in FIG. 1) of tray blank 100 and a portion of exterior surface 202 of cover blank 200, and an interior surface 304 of blank assembly 300 includes interior surface 204 (shown in FIG. 2) of cover blank 200 and interior surface 104 of glue flap 140 and bottom flaps 124, 126, 128, and 130 (shown in FIG. 1) of tray blank 100.

In the illustrated embodiment, interior surface 104 of first side panel 106 is coupled to exterior surface 202 of first side panel 206 to form a first side panel assembly 306. Similarly, interior surface 104 of second side panel 108 is coupled to exterior surface 202 of second side panel 208 to form a second side panel assembly 308. In the example embodiment, first and second side panel assemblies 306 and 308 are formed using adhesive 305 applied between first side panel 106 and first side panel 206, and/or between second side panel 108 and second side panel 208. In one embodiment, adhesive 305 is applied adjacent to cutouts 250 and 252 (e.g., in an area of overlap of the respective side panels, such as below cutouts 250 and 252).

Blank assembly 300 also includes a first end panel assembly 310 and a second end panel assembly 312. First end panel assembly 310 includes first end panels 110 and 210. Second end panel assembly 312 includes second end panels 112 and 212. In the example embodiment, first end panel assembly 310, first side panel assembly 306, second end panel assembly 312, and second side panel assembly 308 are coupled together in series. In addition, glue panel 140 and glue panel 240 are generally aligned in a vertical direction. As shown in FIG. 3, when blank assembly 300 is formed by arranging tray blank 100 and cover blank 200 in an overlapping relationship, glue panel 140 and 240 are aligned such that a combined height H₅ of the two glue panels 140 and 240 corresponds to a height of second side panel 208, or to a height of the container to be formed from blank assembly 300. Notably, glue panels 140 and 240 remain separate and uncoupled from one another and, in the example embodiment, do not overlap with one another.

In some embodiments, blank assembly 300 may be formed manually, semi-automatically, or automatically. For example, either or both of the application of adhesive 305 and the overlapping and coupling of tray blank 100 and cover blank 200 may be performed manually or automatically via a machine. For example, tray blank 100 and cover blank 200 may be joined as described in co-pending U.S. patent application Ser. No. 14/860,385, which is hereby incorporated herein by reference in its entirety.

FIG. 4 is a perspective view of an example embodiment of a container 400 formed from blank assembly 300 (shown in FIG. 3) in a shipping configuration 401. To form container 400, first and second side panel assemblies 306 and 308 and first and second end panel assemblies 310 and 312 are rotated toward interior surface 304 (all shown in FIG. 3). More specifically, first end panel assembly 310 is rotated toward interior surface 304 (“inwardly”) to form a first end wall 410 of container 400. First side panel assembly 306 is rotated inwardly to form a first side wall 406 of container 400. First side wall 406 includes cutout 250 (shown in FIG. 2), which is at least partially exposed above free edge 146 of first side panel 106. Further, second end panel assembly 312 is rotated inwardly to form a second end wall 412 of container 400, parallel to first end wall 410. Second side panel assembly 308 is rotated toward interior surface 304 to form a second side wall 408 of container 400, parallel to first side wall 406. Second side wall 408 includes second cutout 252, which is at least partially exposed above free edge 150 of second side panel 108 (shown in FIG. 1).

In addition, glue panels 140 and 240 are rotated inwardly to couple interior surfaces 104 and 204, respectively, of glue panels 140 and 240 to exterior surfaces 102 and 202 of first end panels 110 and 210 of tray blank 100 and cover blank 200, respectively. In particular, glue panel 140 is only coupled to first end panel 110 (i.e., not to first end panel 210), and glue panel 240 is only coupled to first end panel 210 (i.e., not to first end panel 110). Glue panels 140 and 240 may be coupled to respective end panels 110 and 210, for example, using an adhesive (not shown). In the illustrated embodiment, first end wall 410 includes glue panels 140 and 240.

In addition, first, second, third, and fourth bottom flaps 124, 126, 128, and 130 (all shown in FIG. 1) are rotated inwardly to form a bottom wall 414 of container 400. More specifically, first and third bottom flaps 124 and 128 are rotated about respective fold lines 132 and 136 (both shown in FIG. 1) toward interior surface 304 of respective first and second end panel assemblies 310 and 312. First and third bottom flaps 124 and 128 may be rotated before, concurrently, and/or after first and second end panel assemblies 310 and 312 are rotated. After rotation of first and third bottom flaps 124 and 128, second and fourth bottom flaps 126 and 130 are rotated about respective fold lines 134 and 138 (both shown in FIG. 1) toward interior surface 304 of respective first and second side panel assemblies 306 and 308, and are coupled to first and third bottom flaps 124 and 128, such as by using an adhesive.

Similarly, first, second, third, and fourth top flaps 224, 226, 228, and 230 are rotated inwardly to form a top wall 416 of container 400. More specifically, first and third top flaps 224 and 228 are rotated about respective fold lines 232 and 236 (both shown in FIG. 2) toward interior surface 304 of respective first and second end panel assemblies 310 and 312. First and third top flaps 224 and 228 may be rotated before, concurrently, and/or after first and second end panel assemblies 310 and 312 are rotated. After rotation of first and third tops flaps 224 and 228, second and fourth top flaps 226 and 230 are rotated about respective fold lines 234 and 238 (both shown in FIG. 2) toward interior surface 304 of respective first and second side panel assemblies 306 and 308, and are coupled to first and third top flaps 224 and 228. More specifically, in the example embodiment, first portion 260 of second top flap 226 is rotated about fold line 264 such that tabs 266 of second top flap 226 may be engaged with cutouts 274 of first and third top flaps 224 and 228 such that top wall 416 may be selectively transitioned between a closed configuration (in which tabs 266 engage cutouts 274) and an open position, without using adhesive.

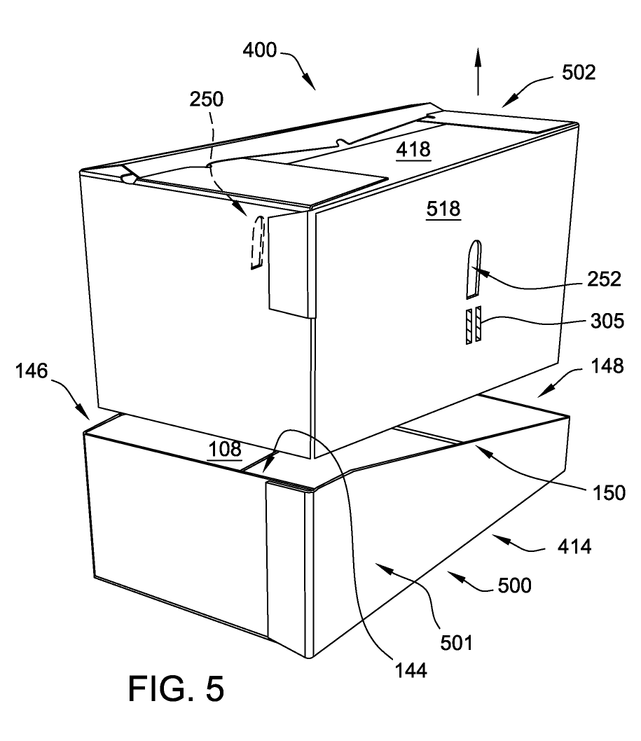

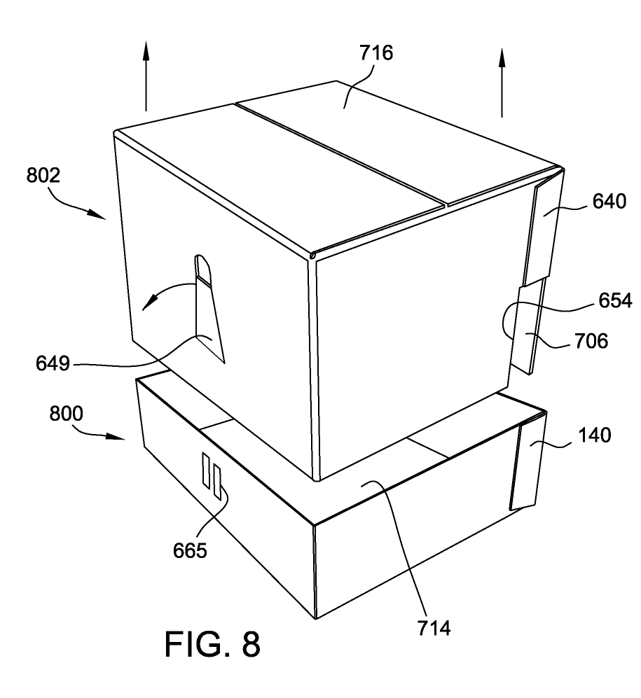

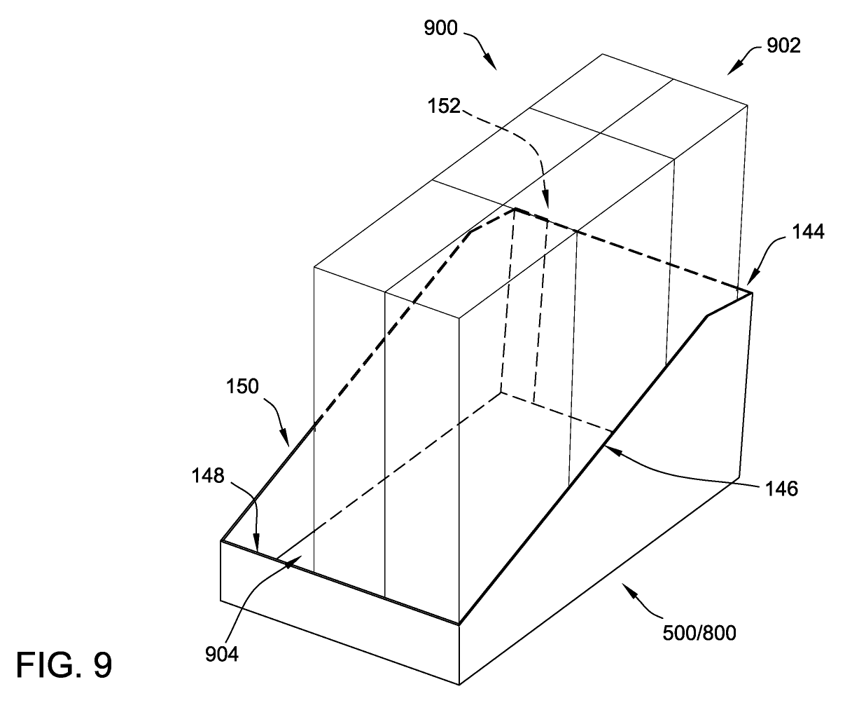

FIG. 5 is a perspective view of container 400 separated into a tray 500 and a removable cover 502. Tray 500 is generally formed from tray blank 100 (shown in FIG. 1), and removable cover 502 is generally formed from cover blank 200 (shown in FIG. 2). Container 400 formed from blank assembly 300 (shown in FIG. 3) may be considered a “tray outside” embodiment of an RRP, in which cover 502 is at least partially encased in tray 500. In the “tray outside” RRP embodiment (i.e., container 400), tray top edge 154 is exposed (i.e., is visible outside of cover 502). To separate cover 502 from tray 500, in the illustrated embodiment, the adhesive bond of adhesive 305 is broken. For example, a user may put a tool or a finger into one of cutouts 250 and 252, and may exert an outward force on the corresponding one of first and second side panels 106 and 108 (i.e., pushing it away from the one of first and second side panels 206 and 208 to which it is coupled). Such movement of the one of first and second side panels 106 and 108 may break the adhesive bond between the corresponding pair of side panels 106 and 206, or 108 and 208. The process may be repeated for both side walls 406 and 408 of container 400. Subsequently, cover 502 is detached from tray 500 by lifting cover 502 out of tray 500. As glue panels 140 and 240 remained separate and only coupled to the respective end panel 110 or 210 of the corresponding blank, the user need not cut, break, or otherwise exert any effort in separating a single-piece glue panel. Accordingly, container 400 is more readily transitioned from shipping configuration 401 (shown in FIG. 4) to a display or “retail ready” configuration (as shown in FIG. 9). Moreover, the user can transition container 400 from the shipping configuration 401 without damaging tray 500, specifically an exterior surface 501 thereof, such that tray 500 retains its aesthetic appeal in the display configuration.

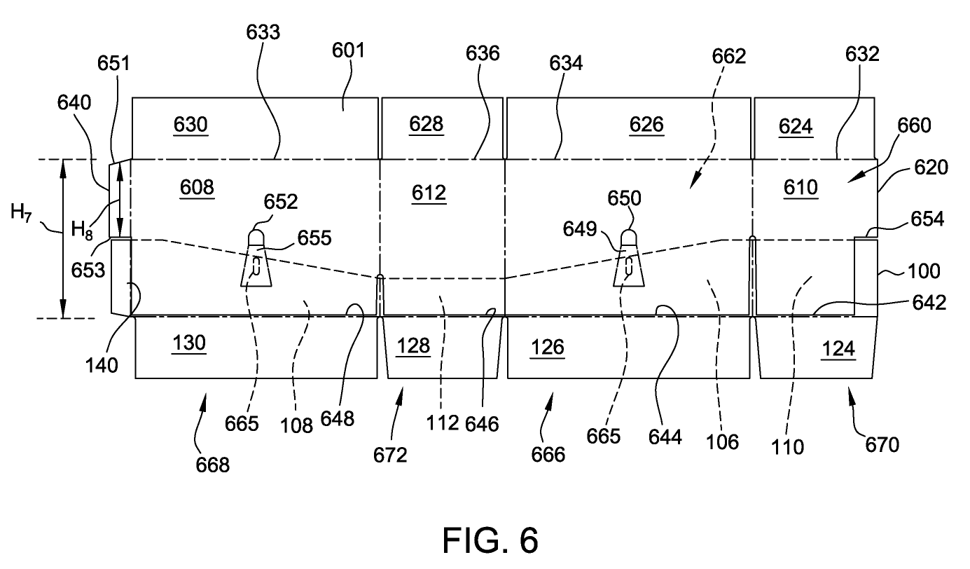

FIG. 6 is a top plan view of an alternative configuration of a blank assembly 600 including tray blank 100 (shown in FIG. 1) in an overlapping relationship with an alternative cover blank 601. Blank assembly 600 is used to form an alternative configuration of a container 700 (shown in FIG. 7). In the example embodiment, cover blank 601 includes an exterior surface 602 and an interior surface 604. As shown in FIG. 6, cover blank 601 includes a series of aligned side panels and end panels connected together by a plurality of preformed, generally parallel, fold lines. Specifically, the side panels include a first side panel 606 and a second side panel 608, and the end panels include a first end panel 610 and a second end panel 612. First end panel 610, first side panel 606, second end panel 612, and second side panel 608 are coupled together in series along preformed fold lines 614, 616, and 618, respectively. First end panel 610 extends from a first free edge 620 to fold line 614, first side panel 606 extends between first and second end panels 610 and 612 from fold line 614 to fold line 616, second end panel 612 extends between first side panel 606 and second side panel 608 from fold line 616 to fold line 618, and second side panel 608 extends from fold line 618 to a fold line 622. A glue panel 640 extends from second side panel 608 along fold line 622, to a second free edge 623.

Cover blank 601 also includes a first top flap 624 coupled to first end panel 610 along a fold line 632. A second top flap 626 is coupled to first side panel 606 along a fold line 634, a third top flap 628 is coupled to second end panel 612 along a fold line 636, and a fourth top flap 630 is coupled to second side panel 608 along a fold line 638. Fold lines 632, 634, 636, and 638 are generally parallel to one another and generally perpendicular to fold lines 614, 616, 618, 620, and 622.

Cover blank 601 further includes a first bottom edge 642 of first end panel 610, a second bottom edge 644 of first side panel 606, a third bottom edge 646 of second end panel 612, and a fourth bottom edge 648 of second side panel 608. Bottom edges 642, 644, 646, and 648 are substantially continuous with one another and collectively define a “clean” cover bottom edge 647 of cover blank 601 (e.g., no detritus from removal of a perforated section).

In addition, first side panel 606 includes a first cutout 650, and second side panel 608 includes a second cutout 652. First cutout 650 and second cutout 652 may have any suitable size, shape, and/or configuration that enables container 700 to function as described herein. Cutout 650 partially defines a release tab 649. Release tab 649 is further defined in first side panel 606 by a score line or line of perforations, such that release tab 649 may be at least partially de-coupled from first side panel 606. Similarly, cutout 652 partially defined a release tab 655. Release tab 655 is further defined in second side panel 608 by a score line or line of perforations, such that release tab 655 may be at least partially de-coupled from second side panel 608. In alternative embodiments, cover blank 601 does not include cutouts 650 and/or 652, and/or release tabs 649 and/or 655. In addition, first end panel 610 has a cutout 654 defined in free edge 620 and bottom edge 642 thereof. Cutout 654 may accordingly be referred to as a “corner cutout” 654.

In the illustrated embodiment, glue panel 640 has a height H₆ that extends from a top edge 651 to a bottom edge 653 of glue panel 640. Height H₆ does not, in the illustrated embodiment, extend a full height of cover blank 601, or even a full height of second side panel 608. Put another way, glue panel 640 extends only partially along second side panel 608, or fold line 622 extends only partially along second side panel 608. As described further herein, having glue panel 640 be “shorter” than the rest of cover blank 601 facilitates the simultaneous folding of cover blank 601 and tray blank 100 (collectively a blank assembly 600) about a mandrel to form a container therefrom.

In the illustrated embodiment, free edges 620 and 623 and fold lines 614, 616, 618, and 622 are generally parallel to one another and are generally perpendicular to fold lines 632, 634, 636, and 638, and to bottom edges 642, 644, 646, and 648.

To form blank assembly 600, exterior surface 102 of tray blank 100 is coupled to interior surface 604 of cover blank 601. More specifically, fold lines 132, 134, 136, and 138 of tray blank 100 are aligned with bottom edges 642, 644, 646, and 648 of cover blank 601, respectively, such that cover blank 601 at least partially covers exterior surface 102 of tray blank 100. Accordingly, an exterior surface 660 of blank assembly 600 includes exterior surface 602 of cover blank 601 and a portion of exterior surface 102 of tray blank 100, and an interior surface 662 of blank assembly 600 includes a portion of interior surface 604 of cover blank 601 and interior surface 104 of tray blank 100.

In the illustrated embodiment, exterior surface 102 of first side panel 106 is coupled to interior surface 604 of first side panel 606 to form a first side panel assembly 666. Similarly, exterior surface 102 of second side panel 108 is coupled to interior surface 604 of second side panel 608 to form a second side panel assembly 668. In the example embodiment, first and second side panel assemblies 666 and 668 are formed using adhesive 665 applied between first side panel 106 and first side panel 606, and/or between second side panel 108 and second side panel 608. In one embodiment, adhesive 665 is applied adjacent to cutouts 650 and 652, particular on exterior surface 602 of release tabs 649 and 655. In alternative embodiments, adhesive 665 may be applied in an area of overlap of the respective side panels, such as at any position below cutouts 650 and 652. In alternative embodiments, an adhesive, not shown, may be applied to first end panel 110 so that blank assembly 600 may be formed more easily.

Blank assembly 600 also includes a first end panel assembly 670 and a second end panel assembly 672. First end panel assembly 670 includes first end panels 110 and 610. Second end panel assembly 672 includes second end panels 112 and 612. In the example embodiment, first end panel assembly 670, first side panel assembly 666, second end panel assembly 672, and second side panel assembly 668 are coupled together in series. In addition, glue panel 140 and glue panel 640 are generally aligned in a vertical direction. As shown in FIG. 6, when blank assembly 600 is formed by arranging tray blank 100 and cover blank 601 in an overlapping relationship, glue panels 140 and 240 are aligned such that a combined height H₇ of the two glue panels 140 and 640 corresponds to a height of second side panel 608, or to a height of the container to be formed from blank assembly 600. Notably, glue panels 140 and 640 remain separate and uncoupled from one another and, in the example embodiment, do not overlap with one another.

In some embodiments, blank assembly 600 may be formed manually, semi-automatically, or automatically. For example, either or both of the application of adhesive 665 and the overlapping and coupling of tray blank 100 and cover blank 601 may be performed manually or automatically via a machine. For example, tray blank 100 and cover blank 601 may be joined as described in co-pending U.S. patent application Ser. No. 14/860,385.

FIG. 7 is a perspective view of an example embodiment of a container 700 formed from blank assembly 600 (shown in FIG. 6) in a shipping configuration 701. To form container 700, first and second side panel assemblies 666 and 668 and first and second end panel assemblies 670 and 672 are rotated toward interior surface 662 (all shown in FIG. 6). More specifically, first end panel assembly 670 is rotated toward interior surface 662 (“inwardly”) to form a first end wall 710 of container 700. First side panel assembly 666 is rotated inwardly to form a first side wall 706 (see FIG. 8) of container 700. First side wall 706 includes cutout 650 and release tab 649. Further, second end panel assembly 672 is rotated inwardly to form a second end wall 712 of container 700, parallel to first end wall 710. Second side panel assembly 668 is rotated inwardly to form a second side wall 708 of container 700, parallel to first side wall 706. Second side wall includes second cutout 652 and release tab 655.

In addition, glue panels 140 and 640 are rotated inwardly to couple interior surfaces 104 and 604, respectively, of glue panels 140 and 640 to exterior surfaces 102 and 602 of first end panels 110 and 610 of tray blank 100 and cover blank 601, respectively. In particular, glue panel 140 is only coupled to first end panel 110 (i.e., not to first end panel 610), and glue panel 640 is only coupled to first end panel 610 (i.e., not to first end panel 110). Glue panels 140 and 640 may be coupled to respective end panels 110 and 610, for example, using an adhesive (not shown). In the illustrated embodiment, first end wall 710 includes glue panels 140 and 640. Corner cutout 654 receives glue panel 140 therein. Put another way, corner cutout 654 facilitates coupling glue panel 140 directly to first end panel 110.

In addition, first, second, third, and fourth bottom flaps 124, 126, 128, and 130 (all shown in FIG. 1) are rotated inwardly to form a bottom wall 714 of container 700 (see FIG. 8), as described above with respect to bottom wall 414 of container 400 (shown in FIG. 4). Similarly, first, second, third, and fourth top flaps 624, 626, 628, and 630 (all shown in FIG. 6) are rotated inwardly to form a top wall 716 of container 700. More specifically, first and third top flaps 624 and 628 are rotated about respective fold lines 632 and 636 (both shown in FIG. 6) toward interior surface 662 of respective first and second end panel assemblies 670 and 672. First and third top flaps 624 and 628 may be rotated before, concurrently, and/or after first and second end panel assemblies 670 and 672 are rotated. After rotation of first and third tops flaps 624 and 628, second and fourth top flaps 626 and 630 are rotated about respective fold lines 634 and 638 (both shown in FIG. 6) toward interior surface 662 of respective first and second side panel assemblies 666 and 668, and are coupled to first and third top flaps 624 and 628.

FIG. 8 is a perspective view of container 700 (shown in FIG. 7) separated into a tray 800 and a removable cover 802. Tray 800 is generally formed from tray blank 100 (shown in FIG. 1) and is substantially similar to tray 500 (shown in FIG. 5). Removable cover 802 is generally formed from cover blank 601 (shown in FIG. 6). Container 700 formed from blank assembly 600 (also shown in FIG. 6) may be considered a “tray inside” embodiment of an RRP, in which tray 800 is encased in cover 802. To separate cover 802 from tray 800, in the illustrated embodiment, the adhesive bond of adhesive 665 is broken. For example, a user may put a tool or a finger into one of cutouts 650 and 652, and exert an outward force on the corresponding one of the release tabs 649 and 655 (i.e., pushing it away from the one of first and second side panels 106 and 108 to which it is coupled). Such force on the release tab 649 or 655 may break the adhesive bond between the respective release tab and the panels 106 or 108 to which it is coupled. The process may be repeated for both side walls 706 and 708 of container 700. Subsequently, cover 802 is detached from tray 800 by lifting cover 802 off of tray 800. As glue panels 140 and 640 remained separate and only coupled to the respective end panel 110 or 610 of the corresponding blank, the user need not cut, break, or otherwise exert any effort in separating a single-piece glue panel. Accordingly, container 700 is more readily transitioned from shipping configuration 801 to a display or “retail ready” configuration (shown in FIG. 9). In the “tray inside” RRP embodiment (i.e., container 700), the container's exterior surface is substantially smooth or regular. Tray top edge 154 is surrounded by or encased in cover 802, which may faciliate reducing bending, tearing, or other damage to tray top edge 154 during storage and/or transport of container 700. Accordingly, the aesthetic appeal of the “clean” tray top edge 154 may be maintained.

FIG. 9 is a perspective view of tray 500 of container 400 (shown in FIG. 5) or tray 800 of container 700 (shown in FIG. 8) in a display configuration 901, in which tray 500/800 may support products 902 for display. As described above, to open container 400/700, removable cover 502/802 is detached from tray 500/800 by manually breaking an adhesive bond therebetween. Cover 502/802 is the lifted away from tray 500/800, making a display area 904 visible, to facilitate displaying products 902 supported within tray 500/800. The removal of cover 502/802 facilitates display of products 902 in, and removal of products 902 from, tray 500/800. Moreover, top edges 144, 146, 148, 150, and 152 (i.e., tray top edge 154) provide clean edges of tray 500/800 to enhance aesthetics of, and ease of reaching into, display area 904.

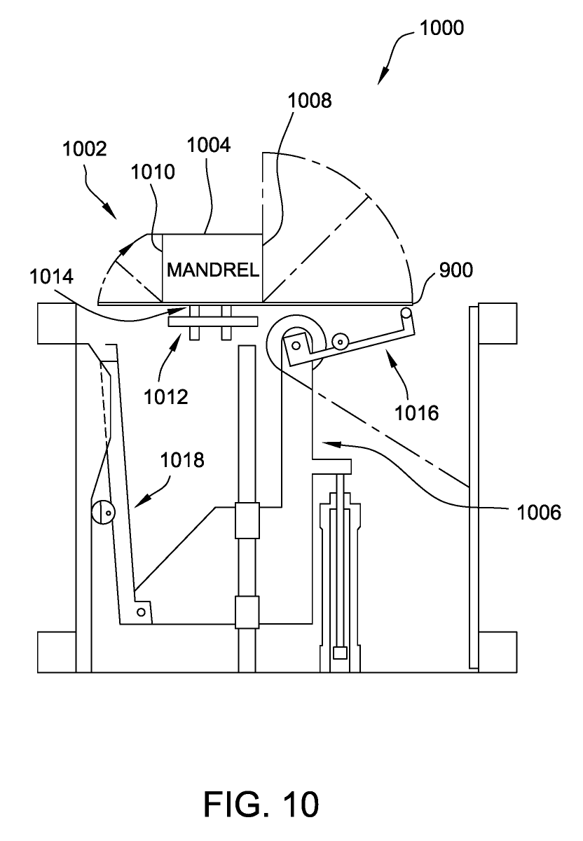

FIGS. 10-14 are side views of a portion of a machine 1000 used to form container 400 (shown in FIG. 4) from blank assembly 300 (shown in FIG. 3). It should be readily understood that machine 1000 may be used to form container 700 (shown in FIG. 7) from blank assembly 600 (shown in FIG. 6). As such, wherever reference is made to specific portions of blank assembly 300, it should be understood that the same processes or steps may be performed on corresponding portions of blank assembly 600.

A folding section 1002 of machine 1000 is illustrated, folding section 1002 including a mandrel 1004 mounted on a body 1006 of machine 1000. Mandrel 1004 has an external shape that is complimentary to at least a portion of an internal shape of container 400. In some embodiments, machine 1000 includes one or more sections or components upstream of folding section 1002, such as a transfer section for transferring blank assemblies 300 (or 600) from a hopper, an adhesive section for applying adhesive to one or more portions of blank assembly 300 (e.g., to internal surface 104, 204 of glue panels 140, 240, respectively, and/or an external surface 302 of 310), and a pusher assembly that guides blank assembly 300 through machine 1000. In particular, such a pusher assembly may position blank assembly 300 underneath mandrel 1004, specifically such that first side panel assembly 306 is positioned underneath mandrel 1004 and fold lines 114, 116, 214, 216 are aligned with respective outer edges 1008, 1010 of mandrel 1004.

A lifting assembly (generally designated by 1012) lifts blank assembly 300 and pushes first side panel assembly 306 tight against the mandrel 1004. More specifically, a member (generally designated by 1014 and sometimes referred to as a pressure plate) of the lifting assembly 1012 engages first side panel assembly 306 and pushes first side panel assembly 306 tight against mandrel 1004. A member 1016 of machine 1000 engages at least one of second end panel assembly 312 and second side panel assembly 308 and wraps second end panel assembly 312 and second side panel assembly 308 around mandrel 1004. Although any suitably configured member may be used to wrap second end panel assembly 312 and second side panel assembly 308 around mandrel 1004 without departing from the scope of the present disclosure, in the exemplary embodiment the member 1016 is an arm rotatably mounted to machine body 1006. Additionally, a member (generally designated by 1018) engages first end panel assembly 310 and wraps first end panel assembly 310 around mandrel 1004.

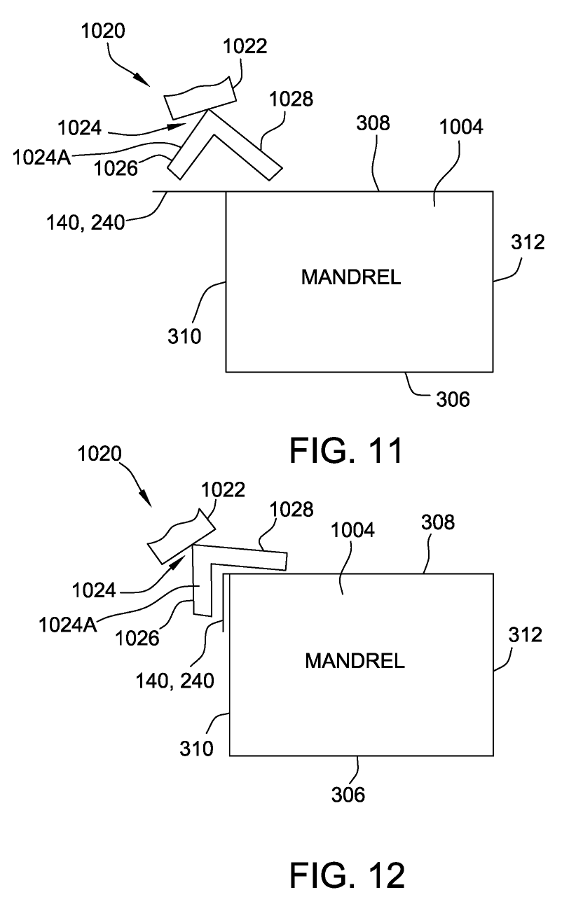

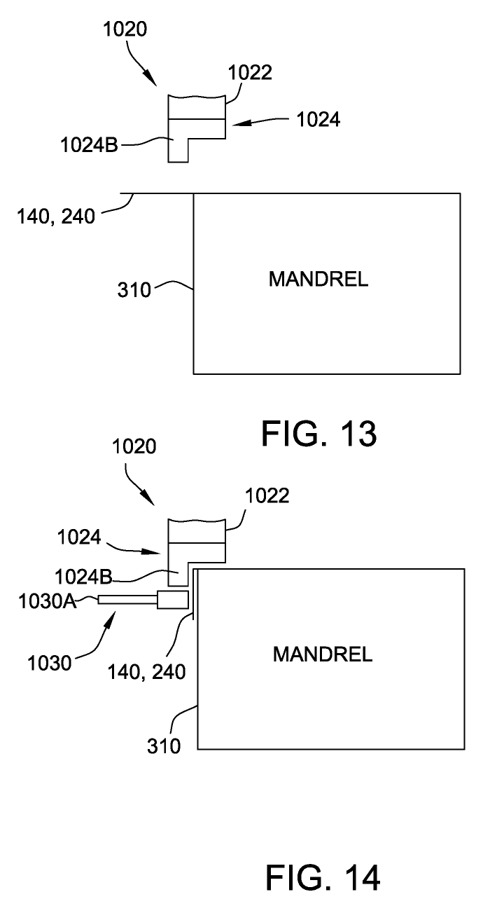

As shown in FIGS. 11-14, machine 1000 includes a presser member 1020 for folding glue panels 140, 240 over a portion of first end panel assembly 310. Presser member 1020 also compresses the adhesive applied to glue panels 140, 240 (and/or to first end panel assembly 310) to secure glue panels 140, 240 to first end panel assembly 310. Specifically, presser member 1020 includes an arm 1022 rotatably mounted on body 1006 for rotation with respect to body 1006, and a tool (generally designated by 1024, designated specifically by 1024A with respect to FIGS. 11, 12, and 15 and 1024B with respect to FIGS. 13, 14, and 16) extending from arm 1022 for folding glue panels 140, 240 and compressing the adhesive between glue panels 140, 240 and first end panel assembly 310. Tool 1024 is generally shaped complimentary to a shape of an external portion of container 400. Specifically, tool 1024A includes a first extension 1026 and a second extension 1028. Second extension 1028 extends at an angle greater than zero with respect to the first extension 1026 such that first and second extensions 1026, 1028 are not parallel. Of course, the particular angle between first and second extensions 1026, 1028 will depend upon the shape of the external portion of container 400. Glue panels 140, 240 and first end panel assembly 310 are generally perpendicular to each other in the embodiments illustrated and described herein, and so first and second extensions 1026, 1028 are angled at about 90° with respect to each other. Of course, first and second extensions 1026, 1028 may have other angles and/or shapes from those described and/or illustrated herein without departing from the scope of the present disclosure.

In some embodiments, tool 1024 (i.e., tool 1024B) is generally fixedly mounted on arm 1022 such that tool 1024 generally does not move with respect to arm 1022. However, in other embodiments, tool 1024 (i.e., tool 2014A) is rotatably mounted on arm 1022 for rotation with respect to arm 1022. For example, as shown in FIGS. 11 and 12, as tool 1024A moves towards mandrel 1004, second extension 1028 contacts second side panel assembly 308, causing tool 1024A to rotate with respect to arm 1022 such that first extension 1026 is forced against glue panels 140, 240 to compress the adhesive between glue panels 140, 240 and first end panel assembly 310. In another embodiment illustrated in FIGS. 13 and 14, another presser member (generally designated by 1030) is used in combination with an embodiment of tool 1024B that is fixedly mounted to arm 1022. Presser member 1030 is movably mounted on body 1006 for movement with respect to body 1006 and mandrel 1004. Tool 1024B folds glue panels 140, 240 over first end panel assembly 310 and holds glue panels 140, 240 in place as presser member 1030 moves to contact glue panels 140, 240 and compress the adhesive between glue panels 140, 240 and first end panel assembly 310. Although presser member 1030 may include any suitable device for moving with respect to body 1006 and mandrel 1004 to compress glue panels 140, 240 without departing from the scope of the present disclosure, in one embodiment, presser member 1030 includes at least one of a hydraulic and a pneumatic cylinder.

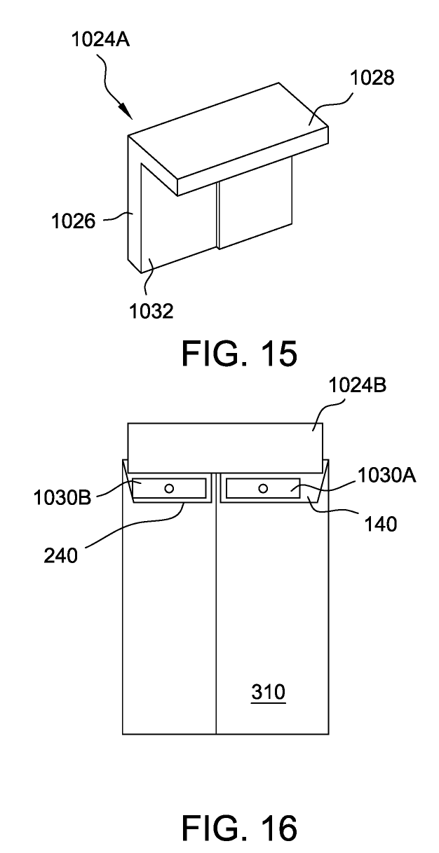

In the example embodiment, glue panel 140 and glue panel 240 may need to be compressed to different depths, with respect to first end panel assembly 310. More particularly, glue panel 140 is folded about the thickness of two layers sheet material, including the thickness of first end panel 110 and the thickness of first end panel 210. Glue panel 240 is only folded about the thickness of one layer of sheet material, including first end panel 210. Accordingly, as shown in FIG. 15, tool 1024A may include a surface 1032 (e.g., of first extension 1026) that is stepped or otherwise varying in depth, such that when tool 1024A contacts glue panels 140 and 240 and compresses glue panels 140 and 240 against first end panel assembly 310, both glue panels 140 and 240 are compressed tightly against first end panel assembly 310 (i.e., glue panel 140 is pressed tightly against first end panel 110, and glue panel 240 is pressed tightly against first end panel 210). FIG. 16 illustrates, in an alternative embodiment, an end view of machine 1000 (specifically, folding section 1002). With respect to the embodiment of folding section 1002 illustrated in FIGS. 13 and 14, presser member 1030 may include two discrete presser members 1030A, 1030B that are independently configured to compress the individual, separate glue panels 140 and 240 tightly at their respective depths.

With respect to folding glue panels 140, 640 of blank assembly 600, glue panel 140 and glue panel 640 may need to be compressed to different depths, with respect to first end panel assembly 670. More particularly, glue panel 640 is folded about the thickness of two layers sheet material, including the thickness of first end panel 110 and the thickness of first end panel 610. Glue panel 240 is only folded about the thickness of one layer of sheet material, including first end panel 110. Accordingly, tool 1024A may include a surface (not specifically shown) that is substantially the inverse of the surface 1032 shown in FIG. 15, and/or presser member 1030 may include two discrete presser members 1030A, 1030B that are independently configured to compress the individual, separate glue panels 140 and 640 tightly at their respective depths.

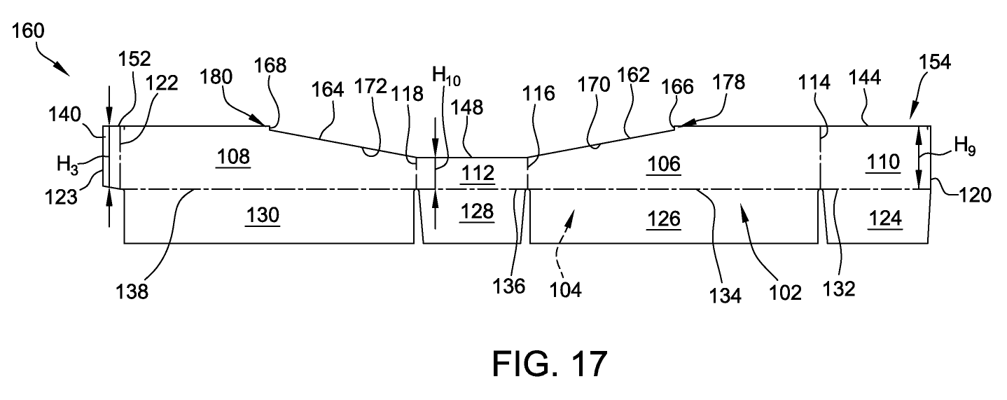

With reference to FIG. 17, an alternative embodiment of a tray blank 160 of sheet material is illustrated. Tray blank 160 is substantially similar to tray blank 100, shown in FIG. 1, but tray blank 160 has a different arrangement of top edges. In particular, tray blank 160 includes a second top edge 162 of first side panel 106 and a fourth top edge 164 of second side panel 108. First portions 174 and 176 of second top edge 162 and fourth top edge 164, respectively, are substantially continuous with other top edges 144, 148, and 152. Second top edge 162 and fourth top edge 164 further include respective angled portions 170 and 172, such that tray blank 160 has a varying height (e.g., from a first height H₉ of first end panel 110 to a second height H₁₀ of second end panel 112). Angled portions 170 and 172 begin at a location defined in first side panel 106 and second side panel 108, respectively, and end at second end panel 112 (e.g., at fold lines 116 and 118, respectively). In the illustrated embodiment, first portion 174 of second top edge 162 is separated from angled portion 170 by a tab 166, defined by a tab edge 178. Likewise, first portion 176 of fourth top edge 164 is separated from angled portion 172 by a tab 168, defined by a tab edge 180. Tab edges 178 and 180 are generally parallel to fold lines 114, 116, 118, and 122.

In the illustrated embodiment, based on the locations of tabs 166, 168 in second and fourth top edges 162, 164, first portion 176 of second top edge 162 and first portion 176 of fourth top edge 152 of tray blank 160 are longer than first portions 155, 157 as shown on tray blank 100, shown in FIG. 1. Further, angled portions 170 and 172 of respective top edges 162 and 164 are shorter than angled portions 156 and 158 of respective top edges 146 and 150 of tray blank 100. However, it should be readily understood that the location of tabs 166, 168 along second and fourth top edges 162, 164 may vary in alternative embodiments from the location shown in FIG. 17. Accordingly, first portions 174, 176 and angled portions 170, 172 may have any suitable length in alternative embodiments. Tray blanks 100 and 160 may be formed using a die cutting machine (not shown). Typically, multiple tray blanks (e.g., five or six blanks) run simultaneously through the die cutting machine, side-by-side as the tray blanks get cut. The different arrangement of top edges 144, 148, 152, 162, and 164, angled portions 170 and 172, and the incorporation of tabs 166 and 168 into tray blank 160 allows for easier separation and easier removal of tray blank 160 when the die cutting machine runs at high speeds, as compared to the separation and removal of tray blank 100 when the die cutting machine runs at high speeds.

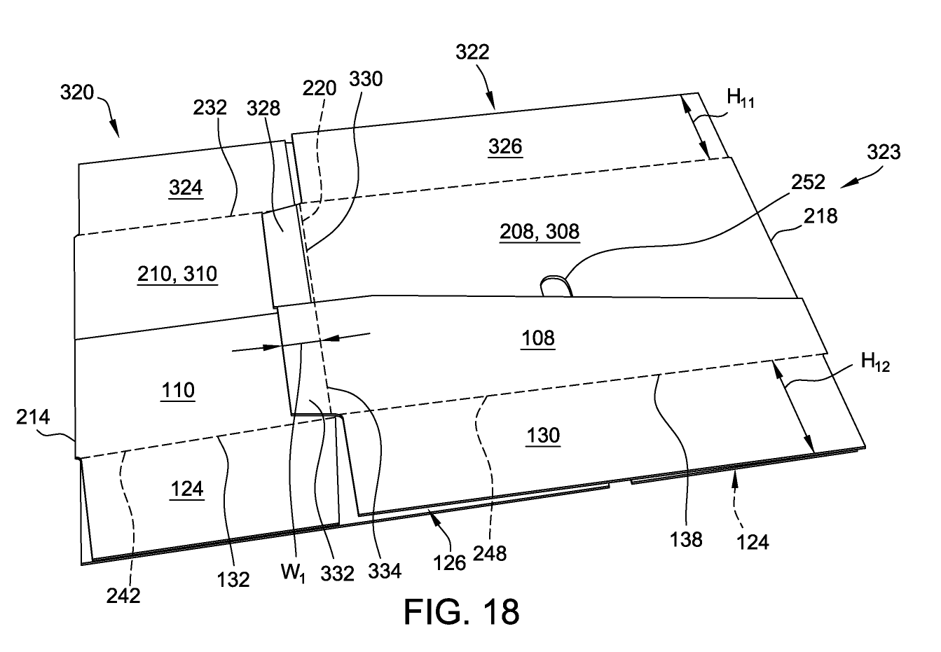

With reference to FIG. 18, an alternative embodiment of a partially formed container 320 in a knocked-down flat (KDF) configuration 322 is illustrated. Partially formed container 320 is formed from a blank assembly (not specifically shown) substantially similar to blank assembly 300 (shown in FIG. 3), but the blank assembly used to form partially formed container 320 has a different arrangement of top flaps. In particular, a cover blank 323 used to form partially formed container 320 includes first and second top flaps 324 and 326, and third and fourth top flaps (not specifically shown) that have the same configuration as first and second top flaps 324 and 326, respectively. Top flaps 324, 326 have height H₁₁, and bottom flaps 124, 130 have height H₁₂. Top flaps 324, 326 are substantially the same shapes as respective bottom flaps 124, 130, except height H₁₁ is less than height H₁₂. Partially formed container 320 includes a glue panel 328 extending from second side panel 208 along a fold line 330 and a glue panel 332 extending from second side panel 108 along a fold line 334. Glue panels 328 and 332 have substantially the same width Wi.

To construct partially formed container 320 from the blank substantially similar to blank assembly 300, first end panel assembly 310 is rotated about fold lines 114, 214 (shown in FIGS. 1 and 2, respectively) toward interior surface 304 (shown in FIG. 3) and second side panel assembly 308 is rotated about fold lines 118, 218 (shown in FIGS. 1 and 2, respectively) towards interior surface 304 such that glue panels 328, 332 overlap first end panel assembly 310. Glue or any suitable adhesive is attached to glue panels 328 and 332, and glue panels 328 and 332 are adhered to exterior surface 302 of first end panel assembly 310. It should be understood that adhesive may be applied to glue panels 328, 332 before or after first end panel assembly 310 and/or second side panel assembly 308 is rotated.

When partially formed container 320 is transitioned to a shipping or fully formed configuration (not specifically shown), the partially formed container is substantially similar to container 400 (shown in FIG. 4). To transition partially formed container 320 from the knocked-down-flat configuration 322 to the shipping configuration, the ends of partially formed container 320 (e.g., end edges defined alone fold lines 114, 214 and 118, 218) can be urged towards one another to erect the container. For example, first end panel assembly 310 and respective coupled glue panels 328 and 332 are rotated along fold lines 330 and 334 such that first end panel assembly 310 and respective glue panels 328 and 332 are substantially perpendicular to second side panel assembly 308. Consequently, this rotation makes first end panel assembly 310 and second end panel assembly 312 (shown in FIG. 3) substantially parallel, and first side panel assembly 306 (also shown in FIG. 3) and second side panel assembly 308 substantially parallel. Bottom flaps 124, 126, 128, and 130 are rotated about respective fold lines to form a bottom wall (e.g., bottom wall 414, shown in FIG. 4) of the container. The contents of the container may be added after sealing or otherwise closing the bottom wall of the container. Subsequently, first and second top flaps 324 and 326, and third and fourth top flaps (not shown) of the container are rotated about respective fold lines to form a top wall of the container. A container in a shipping configuration constructed from partially formed container 320 has a smooth top comprised of first and second top flaps 324 and 326 and third and fourth top flaps (not shown), without the interlocking features illustrated in FIGS. 4 and 5. In the exemplary embodiment, the container in a shipping configuration constructed from partially formed container 320 may have a regular slotted container (RSC) lid which may be sealed with tape or any suitable adhesive.

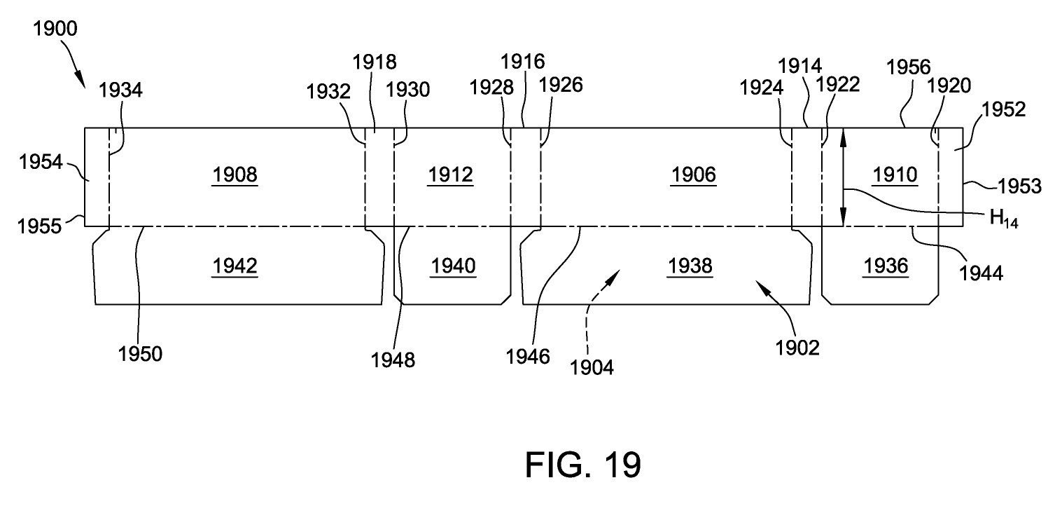

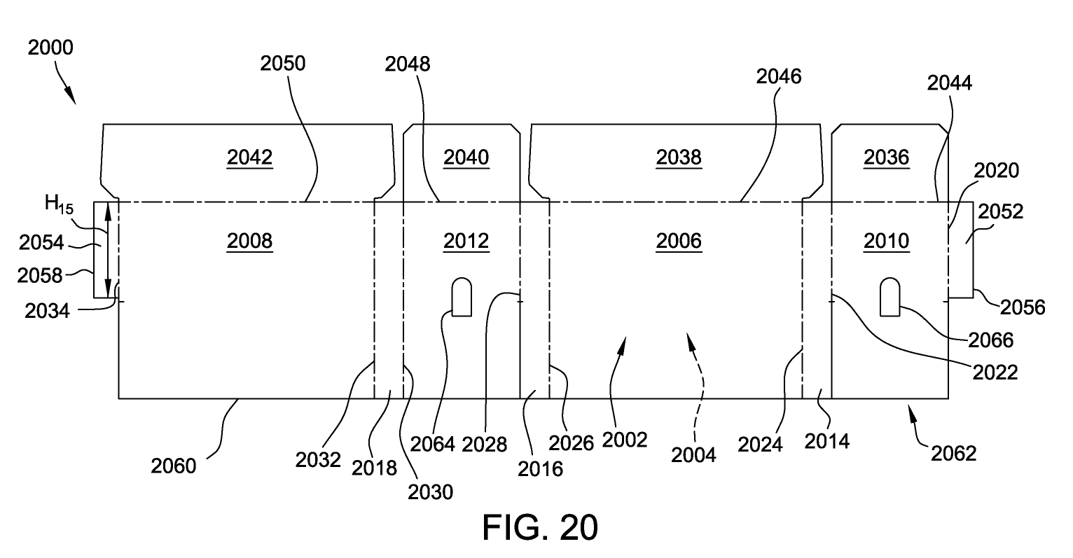

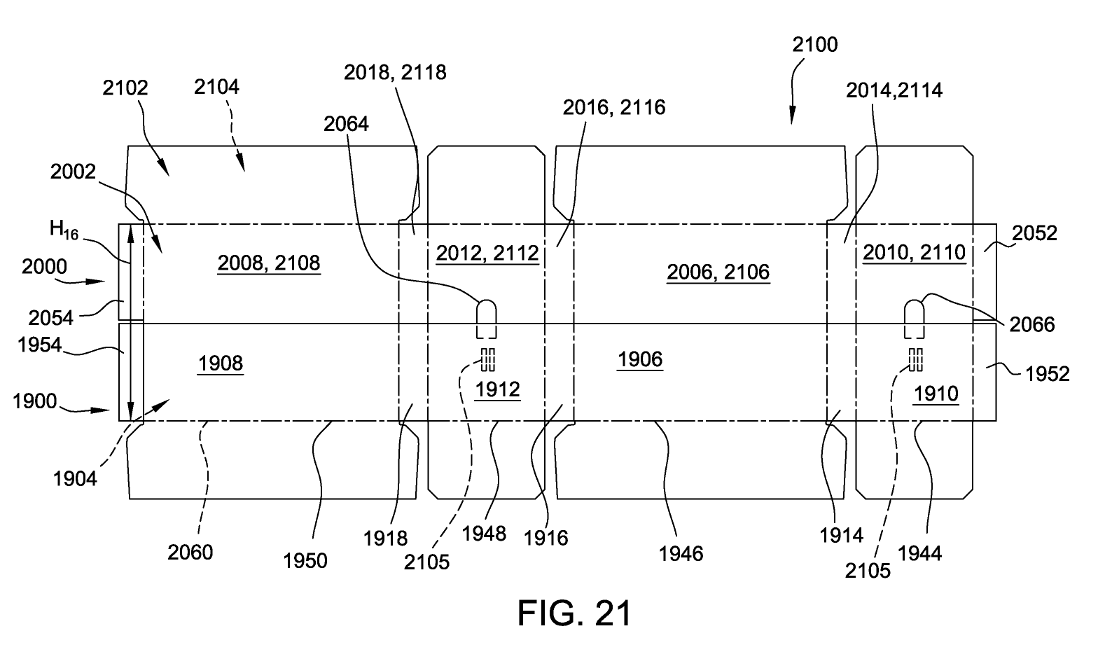

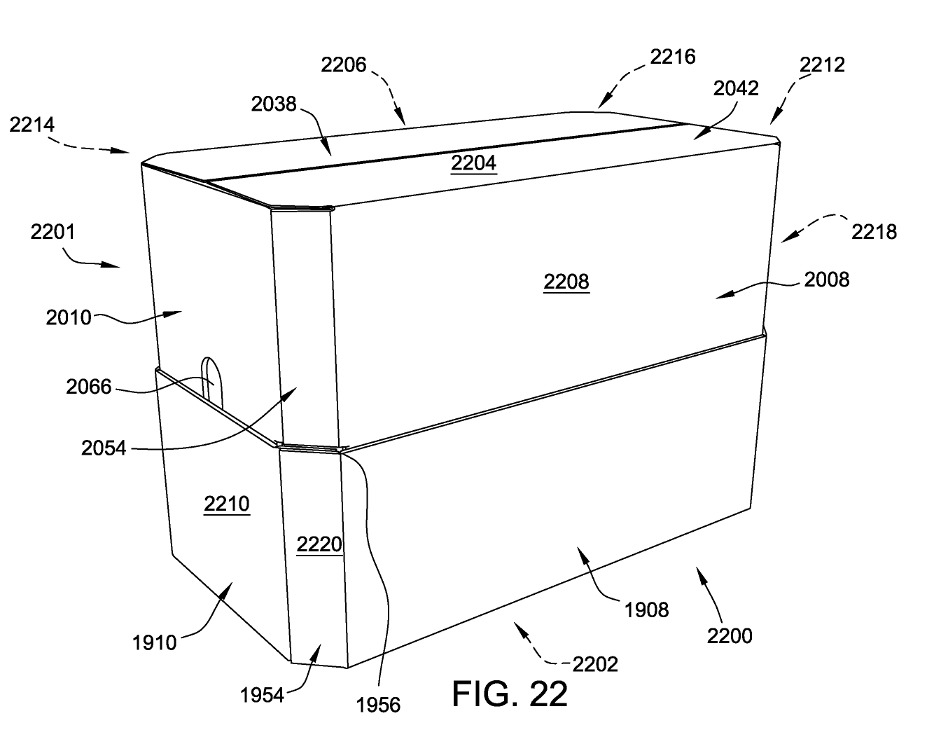

FIG. 19 is an exterior view of an example embodiment of a tray blank 1900 of sheet material that may be used to form a container as described herein. As explained below in more detail, tray blank 1900 is coupled to another blank (a cover blank 2000, shown in FIG. 20) to form a blank assembly 2100 (shown in FIG. 21) that is used to form a container 2200 (shown in FIG. 22). Tray blank 1900 is similar to tray blank 100, shown in FIG. 1, but tray blank 1900 forms a tray of container 2200 having eight sides. In particular, tray blank 1900 includes an exterior surface 1902 and an interior surface 1904. Tray blank 1900 includes a series of aligned side panels, end panels, and corner panels coupled together in series along preformed, generally parallel, fold lines. Specifically, the side panels include a first side panel 1906 and a second side panel 1908, the end panels include a first end panel 1910 and a second end panel 1912, and the corner panels include a first corner panel 1914, a second corner panel 1916, and a third corner panel 1918. First end panel 1910, first corner panel 1914, first side panel 1906, second corner panel 1916, second end panel 1912, third corner panel 1918, and second side panel 1908 are coupled together in series along preformed fold lines 1920, 1922, 1924, 1926, 1928, 1930, 1932, and 1934, respectively. First end panel 1910 extends from fold line 1920 to fold line 1922, first corner panel 1914 extends from fold line 1922 to fold line 1924, first side panel 1906 extends from fold line 1924 to fold line 1926, second corner panel 1916 extends from fold line 1926 to fold line 1928, second end panel 1912 extends from fold line 1928 to fold line 1930, third corner panel extends from 1930 to 1932, and second side panel 1908 extends from fold line 1932 to fold line 1934. A first glue panel 1952 extends from a first free edge 1953 of tray blank 1900 to fold line 1920. A second glue panel 1954 extends from a second free edge 1955 of tray blank 1900 to fold line 1934. First glue panel 1952 or second glue panel 1954 may alternatively be considered a “fourth corner panel.”

Tray blank 1900 also includes a first bottom flap 1936 coupled to first end panel 1910 along a fold line 1944. A second bottom flap 1938 is coupled to first side panel 1906 along a fold line 1946, a third bottom flap 1940 is coupled to second end panel 1912 along a fold line 1948, and a fourth bottom flap 1942 is coupled to second side panel 1908 along a fold line 1950. Fold lines 1944, 1946, 1948, and 1950 are generally parallel to one another and generally perpendicular to fold lines 1920, 1922, 1924, 1926, 1928, 1930, 1932, and 1934.

Tray blank 1900 further includes a top edge 1956 that is substantially continuous across all side, end, and corner panels of tray blank 1900. In other words, tray blank 1900 has a substantially uniform height H₁₄ thereacross.

Turning now to FIG. 20, an exterior view of an example embodiment of a cover blank 2000 of sheet material that is configured to releasably couple to tray blank 1900 (shown in FIG. 19) to form container 2200 (shown in FIG. 22) is illustrated. Cover blank 2000 is similar to cover blank 200 (shown in FIG. 2), but cover blank 2000 forms a cover of container 220 having eight sides. In particular, cover blank 2000 includes an exterior surface 2002 and an interior surface 2004. Cover blank 2000 includes a series of aligned side panels, end panels, and corner panels connected together by a plurality of preformed, generally parallel, fold lines. Specifically, the side panels include a first side panel 2006 and a second side panel 2008, the end panels include a first end panel 2010 and a second end panel 2012, and the corner panels include a first corner panel 2014, a second corner panel 2016, and a third corner panel 2018. First end panel 2010, first corner panel 2014, first side panel 2006, second corner panel 2016, second end panel 2012, third corner panel 2018, and second side panel 2008 are coupled together in series along preformed fold lines 2022, 2024, 2026, 2028, 2030, and 2032, respectively. First end panel 2010 extends from a fold line 2020 to fold line 2022, first corner panel extends from fold line 2022 to 2024, first side panel 2006 extends fold line 2024 to fold line 2026, second corner panel 2016 extends from fold line 2026 to fold line 2028, second end panel 2012 extends from fold line 2028 to fold line 2030, third corner panel 2018 extends from fold line 2030 to fold line 2032, and second side panel 208 extends from fold line 2032 to a fold line 2034. A first glue panel 2052 extends from a first free edge 2056 of cover blank 2000 to fold line 2020. A second glue panel 2054 extends from a second free edge 2058 of cover blank 2000 to fold line 2034. First glue panel 2052 or second glue panel 2054 may alternatively be considered a “fourth corner panel.” In the illustrated embodiment, glue panels 2052 and 2054 have a height H₁₅.

Cover blank 2000 also includes a first top flap 2036 coupled to first end panel 2010 along a fold line 2044. A second top flap 2038 is coupled to first side panel 2006 along a fold line 2046, a third top flap 2040 is coupled to second end panel 2012 along a fold line 2048, and a fourth top flap 2042 is coupled to second side panel 2008 along a fold line 2050. Fold lines 2044, 2046, 2048, and 2050 are generally parallel to one another and generally perpendicular to fold lines 2020, 2022, 2024, 2026, 2028, 2030, 2032, and 2034. Cover blank 2000 further includes a bottom edge 2060 of end, side, and corner panels 2010, 2014, 2006, 2016, 2012, 2018, and 2008. Bottom edge 2060 is substantially continuous and collectively defines a “clean” cover bottom portion 2062 of cover blank 2000 (e.g., no detritus from removal of a perforated section).

In addition, second end panel 2012 includes a first cutout 2064, and first end panel 2010 includes a second cutout 2066. First cutout 2064 and second cutout 2066 may have any suitable size, shape, and/or configuration that enables container 2200 to function as described herein. In alternative embodiments, cover blank 2000 does not include cutouts 2064 and/or 2066.

FIG. 21 is an exterior view of an example embodiment of a blank assembly 2100, including tray blank 1900 overlapping and releasably coupled to cover blank 2000. Blank assembly 2100 is similar to blank assembly 300 (shown in FIG. 3), but blank assembly 2100 forms a container 2200 with eight sides. To form blank assembly 2100, interior surface 1904 of tray blank 1900 is coupled to exterior surface 2002 of cover blank 2000. More specifically, fold lines 1944, 1946, 1948, and 1950 of tray blank 1900 are aligned with bottom edge 2060 of cover blank 2000, such that tray blank 1900 at least partially covers exterior surface 2002 of cover blank 2000. Accordingly, an exterior surface 2102 of blank assembly 2100 includes exterior surface 1902 (shown in FIG. 19) of tray blank 1900 and a portion of exterior surface 2002 of cover blank 2000, and an interior surface 2104 of blank assembly 2100 includes interior surface 2004 (shown in FIG. 20) of cover blank 2000 and interior surface 1904 of glue panel 1954 and bottom flaps 1936, 1938, 1940, and 1942 (shown in FIG. 19) of tray blank 1900.

In the illustrated embodiment, interior surface 1904 of first side panel 1906 is coupled to exterior surface 2002 of first side panel 2006 to form a first side panel assembly 2106. Similarly, interior surface 1904 of second side panel 1908 is coupled to exterior surface 2002 of second side panel 2008 to form a second side panel assembly 2108. Blank assembly 2100 also includes a first end panel assembly 2110 and a second end panel assembly 2112, which are formed respectively by coupling interior surface 1904 of first and second end panels 1910 and 1912 to exterior surface 2002 of first and second end panels 2010 and 2012, respectively. In the example embodiment, first and second end panel assemblies 2110 and 2112 are formed using adhesive 2105 applied between first end panel 1910 and first end panel 2010, and/or between second end panel 1912 and second end panel 2012 (e.g., in an area of overlap of the respective side panels).

In the example embodiment, blank assembly 2100 also includes first corner panel assembly 2114, second corner panel assembly 2116, and third corner panel assembly 2118. First corner panel assembly 2114 includes first corner panels 1914 and 2014. Second corner panel assembly 2116 includes second corner panels 1916 and 2016. Third corner panel assembly 2118 includes third corner panels 1918 and 2018. The corner panel assemblies are formed similarly to the side and end panel assemblies, i.e., by coupling interior surface 1904 to exterior surface 2002 for respective first, second, and third corner panels.

In the example embodiment, first end panel assembly 2110, first corner panel assembly 2114, first side panel assembly 2106, second corner panel assembly 2116, second end panel assembly 2112, third corner panel assembly 2118, and second side panel assembly 2108 are coupled together in series. In addition, glue panels 1952 and 2052 are generally aligned in a vertical direction, and glue panels 1954 and 2054 are generally aligned in a vertical direction. As shown in FIG. 21, when blank assembly 2100 is formed by arranging tray blank 1900 and cover blank 2000 in an overlapping relationship, glue panels 1952, 2052, 1954, and 2054 are aligned such that a combined height H₁₆ of the glue panels (illustrated as the combined height of glue panels 1954 and 2054) corresponds to a height of second side panel 2008, or to a height of container 2200 to be formed from blank assembly 2100. Notably, glue panels 1952 and 2052 and glue panels 1954 and 2054 remain separate and uncoupled from one another and, in the example embodiment, do not overlap with one another.

In some embodiments, blank assembly 2100 may be formed manually, semi-automatically, or automatically. For example, either or both of the application of adhesive 2105 and the overlapping and coupling of tray blank 1900 and cover blank 2000 may be performed manually or automatically via a machine. For example, tray blank 1900 and cover blank 2000 may be joined as described in co-pending U.S. patent application Ser. No. 14/860,385, which is hereby incorporated herein by reference in its entirety.

FIG. 22 is a perspective view of an example embodiment of a container 2200 formed from blank assembly 2100 (shown in FIG. 21) in a shipping configuration 2201. Container 2200 is similar to container 400 (shown in FIG. 4), but container 2200 has eight sides. To form container 2200, first and second side panel assemblies 2106 and 2108, first and second end panel assemblies 2110 and 2112, and first, second, and third corner panel assemblies 2114, 2116, and 2118 are rotated toward interior surface 2104 (all shown in FIG. 21). More specifically, glue panels 1952 and 2052 are rotated toward interior surface 2104 (“inwardly”) to partially form a first corner wall 2220. First end panel assembly 2110 is rotated inwardly to form a first end wall 2210 of container 2200. First end wall 2210 includes cutout 2066, which is at least partially exposed above top edge 1956 (shown in FIG. 19) of first end wall 1910. First corner panel assembly 2114 is rotated inwardly to form a second corner wall 2214 of container 2200. First side panel assembly 2106 is rotated inwardly to form a first side wall 2206 of container 2200. Second corner panel assembly 2116 is rotated inwardly to form a third corner wall 2216 of container 2200. Second end panel assembly 2112 is rotated inwardly to form a second end wall 2212 of container 2200, parallel to first end wall 2210. Second end wall 2212 includes second cutout 2064 (shown in FIG. 20), which is at least partially exposed above top edge 1956 of second end wall 1912 (shown in FIG. 19). Third corner panel assembly 2118 is rotated inwardly to form a fourth corner wall 2218 of container 2200. Second side panel assembly 2108 is rotated inwardly to form a second side wall 2208 of container 2200, parallel to first side wall 2206.

In addition, glue panels 2054 and 1954 are rotated inwardly and coupled to glue panels 2052 and 1952 (shown in FIG. 21) respectively to further form first corner wall 2220 of container 2200. Specifically, interior surfaces 2004 and 1904 of glue panels 2054 and 1954 respectively are coupled to exterior surfaces 2004 and 1904 of glue panels 2052 and 1902 respectively. In particular, glue panel 2054 is only coupled to glue panel 2052 (i.e., not to glue panel 1952), and glue panel 1954 is only coupled to glue panel 1952 (i.e., not to glue panel 2052). In some embodiments, interior surfaces 2004 and 1904 of glue panels 2052 and 1952 respectively are coupled to exterior surfaces 2002 and 1902 of glue panels 2054 and 1954 respectively. Glue panels 2054 and 1954 may be coupled to respective glue panels 2052 and 1952, or vice versa, using an adhesive (not shown). Container 2200, including first corner wall 2220, may be formed using a machine similar to that shown and described with respect to FIGS. 11-16. The machine may include an eight-sided mandrel and a tool sized and shaped to accommodate an eight-sided container (i.e, to accommodate first corner wall 2220).

In addition, first, second, third, and fourth bottom flaps 1936, 1938, 1940, and 1942 (all shown in FIG. 19) are rotated inwardly to form a bottom wall 2202 of container 2200. More specifically, first and third bottom flaps 1936 and 1940 are rotated about respective fold lines 1944 and 1948 (both shown in FIG. 19) toward interior surface 2104 of respective first and second end panel assemblies 2110 and 2112. First and third bottom flaps 1936 and 1940 may be rotated before, concurrently, and/or after first and second end panel assemblies 2110 and 2112 are rotated. After rotation of first and third bottom flaps 1936 and 1940, second and fourth bottom flaps 1938 and 1942 are rotated about respective fold lines 1946 and 1950 (both shown in FIG. 19) toward interior surface 2104 of respective first and second side panel assemblies 2106 and 2108, and are coupled to first and third bottom flaps 1936 and 1940 by means such as an adhesive. Bottom wall 2202 includes first, second, third, and fourth bottom flaps 1936, 1938, 1940, and 1942.

Similarly, first, second, third, and fourth top flaps 2036, 2038, 2040, and 2042 (shown in FIG. 20) are rotated inwardly to form a top wall 2204 of container 2200. More specifically, first and third top flaps 2036 and 2040 are rotated about respective fold lines 2044 and 2048 (both shown in FIG. 20) toward interior surface 2104 of respective first and second end panel assemblies 2110 and 2112. First and third top flaps 2036 and 2040 may be rotated before, concurrently, and/or after first and second end panel assemblies 2110 and 2112 are rotated. After rotation of first and third tops flaps 2036 and 2040, second and fourth top flaps 2038 and 2042 are rotated about respective fold lines 2046 and 2050 (both shown in FIG. 20) toward interior surface 2104 of respective first and second side panel assemblies 2106 and 2108, and are coupled to first and third top flaps 2036 and 2040 by means such as an adhesive. In some embodiments, first, second, third, and fourth top flaps 2036, 2038, 2040, and 2042 may include tabs and cutouts (e.g. tabs 266 and cutouts 274, shown in FIG. 2) to allow transition between an open and closed configuration without use of an adhesive, as illustrated in FIG. 4.

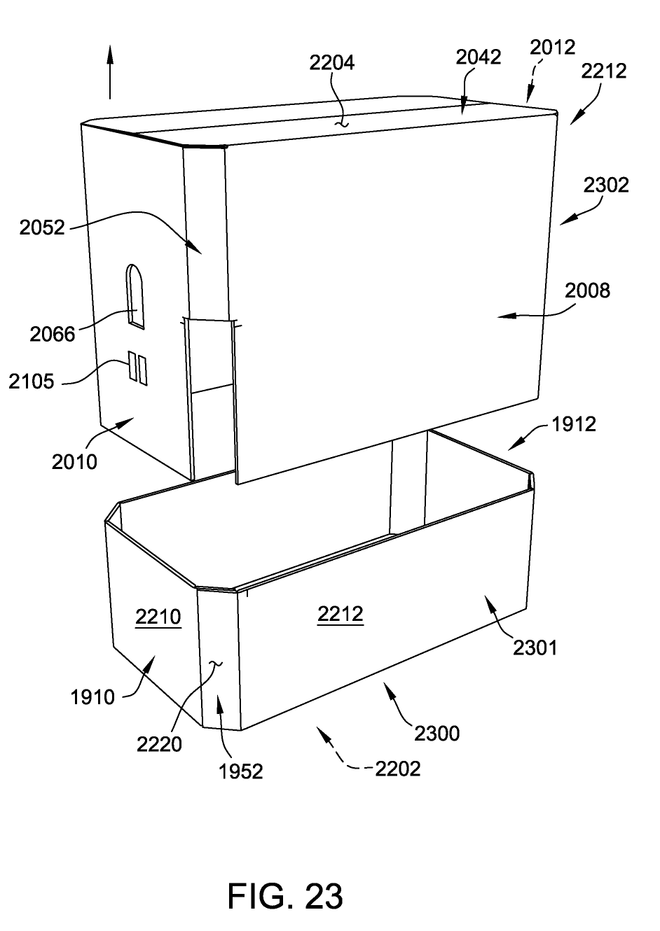

FIG. 23 is a perspective view of container 2200 (shown in FIG. 22) separated into a tray 2300 and a removable cover 2302. Tray 2300 is generally formed from tray blank 1900 (shown in FIG. 19), and removable cover 2302 is generally formed from cover blank 2000 (shown in FIG. 20). Container 2200 formed from blank assembly 2100 (shown in FIG. 21) may be considered a “tray outside” embodiment of an RRP, in which cover 2302 is at least partially encased in tray 2300. In the “tray outside” RRP embodiment, i.e., container 2200, tray top edge 1964 (shown in FIG. 19) is exposed (i.e., is visible outside of cover 2302). To separate cover 2302 from tray 2300, in the illustrated embodiment, the adhesive bond of adhesive 2105 is broken. For example, a user may put a tool or a finger into one of cutouts 2066 and 2064 (shown in FIG. 21), and may exert an outward force on the corresponding one of first and second end panels 1910 and 1912 (i.e., pushing it away from the one of first and second end panels 2010 and 2012 to which it is coupled). Such movement of the one of first and second end panels 1910 and 1912 may break the adhesive bond between the corresponding pair of end panels 1910 and 2010, or 1912 and 2012. The process may be repeated for both end walls 2210 and 2212 of container 2200. Subsequently, cover 2302 is detached from tray 2300 by lifting cover 2302 out of tray 2300. As glue panels 1952 and 2052 remained separate and coupled to only the respective glue panel 1954 or 2054 of the corresponding blank (and vice versa), the user need not cut, break, or otherwise exert any effort in separating a single-piece glue panel. Accordingly, container 2200 is more readily transitioned from shipping configuration 2201 (shown in FIG. 22) to a display or “retail ready” configuration analogous to the configuration shown in FIG. 9. Moreover, the user can transition container 2200 from the shipping configuration 2201 without damaging tray 2300, specifically an exterior surface 2301 thereof, such that tray 2300 retains its aesthetic appeal in the display configuration.

Embodiments of the above-described container are easily constructed from a flexible unitary blank, either manually or using a suitable container-erecting machine, for example by wrapping around a mandrel. Further, embodiments of the above-described container include a removable section that requires separating only two adhesive bonds for removal from a base. The removable section is at least partially defined on the side panels of the container, and does not require additional blank material to be added to the side panels. The container may be oriented in a first orientation, which enables the base to also be easily pulled out from under the products for stand-alone display, or in a second orientation, in which the base remains with side walls and back walls to support the products, but with no front wall such that display and removal of the products is not obstructed.

Example embodiments of a blank and container have been described above in detail. The blank and container are not limited to the specific embodiments described herein, but rather, components of the blank and container and/or steps of the methods of forming the container may be utilized independently and separately from other components and/or steps described herein. Further, the described components and/or method steps can also be defined in, or used in combination with, other apparatus and/or methods, and are not limited to practice with only the apparatus and method as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

While the invention has been described in terms of various specific embodiments, those skilled in the art will recognize that the invention can be practiced with modification within the spirit and scope of the claims.

What is claimed is:

1. A blank assembly for forming a container, the blank assembly comprising:
a tray blank for forming a tray of the container, the tray blank comprising a first plurality of side panels coupled together in series, a first glue panel extending from the first plurality of side panels, and a plurality of bottom panels extending from the first plurality of side panels along a corresponding plurality of bottom fold lines; and
a cover blank for forming a removeable cover of the container, the cover blank comprising a second plurality of side panels coupled together in series and a second glue panel extending from the second plurality of panels,
wherein the tray blank and the cover blank are releasably coupled together in an overlapping relationship such that a free bottom edge of the cover blank is aligned with the plurality of bottom fold lines of the tray blank, and
wherein the first glue panel and the second glue panel are aligned with one another and uncoupled from one another such that each of the first and second glue panels are configured to be independently folded to form the container from the blank assembly.

2. The blank assembly of claim 1, wherein an interior surface of the tray blank is coupled to an exterior surface of the cover blank.

3. The blank assembly of claim 2, wherein at least one side panel of the plurality of second side panels defines a cutout therein.

4. The blank assembly of claim 3, wherein the tray blank and the cover blank are releaseably coupled by adhesive provided between the tray blank and the cover blank, the adhesive positioned adjacent the cutout in an area of overlap between the tray blank and the cover blank.

5. The blank assembly of claim 1, wherein the second glue panel has a height less than a height of the second plurality of side panels.

6. The blank assembly of claim 1, wherein an exterior surface of the tray blank is coupled to an interior surface of the cover blank.

7. The blank assembly of claim 6, wherein at least one side panel of the plurality of second side panels defines a cutout and a release tab therein.

8. The blank assembly of claim 7, wherein the tray blank and the cover blank are releaseably coupled by adhesive provided between the tray blank and the cover blank, the adhesive positioned on the release tab in an area of overlap between the tray blank and the cover blank.

9. The blank assembly of claim 1, wherein the cover blank comprises a corner cutout.

10. A container comprising:
a tray formed from a tray blank, the tray comprising a pair of opposing tray side walls, a pair of opposing tray end walls, and a first glue panel coupled to one of the tray end walls;
a cover formed from a cover blank, the cover releasably coupled to the tray to transition the container from a shipping configuration to a display configuration, the cover comprising a pair of opposing cover side walls aligned with the pair of tray side walls, a pair of opposing cover end walls aligned with the pair of tray end walls, and a second glue panel coupled to one of the cover end walls,
wherein at least a portion of the tray overlaps with at least a portion of the cover, and
wherein the first and second glue panels are vertically aligned with one another and uncoupled from one another.

11. The container of claim 10, wherein an interior surface of the tray is coupled to an exterior surface of the cover.

12. The container of claim 11, wherein at least one cover side wall of pair of cover side walls defines a cutout therein.

13. The container of claim 12, wherein the tray and the cover are releaseably coupled by adhesive provided between the tray and the cover, the adhesive positioned adjacent the cutout in an area of overlap between the tray and the cover.

14. The container of claim 10, wherein the second glue panel has a height less than a height of cover.

15. The container of claim 14, wherein an exterior surface of the tray is coupled to an interior surface of the cover.

16. The container of claim 15, wherein at least one cover side wall of the pair of cover side walls defines a cutout and a release tab therein.

17. The container of claim 16, wherein the tray and the cover are releaseably coupled by adhesive provided between the tray and the cover, the adhesive positioned on the release tab in an area of overlap between the tray and the cover.

18. The container of claim 14, wherein the cover comprises a corner cutout that receives the first glue panel therein.
